(19) United States
(12) Patent Application Publication
(10) Pub. No.: US 2005/0065832 A1
(43) Pub. Date: Mar. 24, 2005

(54) Dynamic calendar reservation

(76) Inventor: Mikko K. Virta, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/668,105

(22) Filed: Sep. 22, 2003

(51) Int. Cl. G06F 17/60

(52) U.S. Cl. 705/8

(57) ABSTRACT

A method and system are adapted to reserve a user's personal time in an electronic schedule of the user. This is done by recording an amount of the user's personal time, and storing at least one respective interval of time during which that amount of personal time is reserved. Each amount of the personal time is less than the respective interval of time. Moreover, the method and system encompass receiving an electronic inquiry about the user's availability for a booking, and then determining or indicating whether the amount of personal time can fit within the respective interval in order to accommodate the booking without any scheduling conflict. A computer readable medium is also provided for implementing this invention, and a device for reserving the user's personal time is included as well. The device comprises a personal time recorder for recording an amount of the personal time, an interval storage unit for storing a respective interval of time during which the amount of personal time is reserved, and a user calendar database for integrating data from the personal time recorder and the interval storage unit into the electronic schedule.

### TECHNICAL FIELD OF THE INVENTION

This invention relates to calendars, and in particular electronic calendar systems.

### BACKGROUND ART

Shared electronic calendar systems are known, for example in Microsoft Office's Outlook which is widely used. In this kind of system one can browse a calendar or calendars of another person or persons, in order to find a free time slot, for a meeting or for some other purpose. After a simultaneous free time slot is found, then one can send an invitation to the other person or persons, so as to book the timeslot. Finally everyone has the same reserved booking in their electronic calendars.

In order to block bookings, and thereby avoid being invited to a meeting at a certain time, one can make reservations in his own calendar. In that way, one can set aside personal time, such as “preparation time 14:00-17:30”, or “answering emails 9:00-10:00”, or “lunch 11:00-11:45.”

This technique of reserving a user's own personal time in the user's own calendar is useful, but it presents problems of rigidity. If someone wants to arrange a meeting with the user, but checks the user's calendar only to find a scheduling conflict, then the user might never be invited to the meeting. The user might have been able to shift his personal time, or situate it differently in the user's calendar, so as to accommodate the meeting, but the user never gets this opportunity due to the rigidity of the way in which he has reserved his own personal time.

One of the many environments for using electronic calendars is the General Packet Radio Service (GPRS) for mobile telecommunications, which offers a third generation environment where scheduling and calendar data can be transferred transparently from and to a mobile terminal. However, calendar applications are important in wired as well as wireless environments, even without GPRS.

When two or more devices are connected by a data link, there are a number of schedule or calendar functions that they can perform together. In fixed networks, schedules and calendars are handled either with a document server (as in the World Wide Web), with a dedicated groupware application, or simply by just copying the calendar document from one device to another via a common file system. The methods that are currently used are functioning well in PC systems and distributed networks.

An especially useful implementation of shared functions technology is a group calendar. There are several implementations for group calendars in office systems with networked PCs. Thus far there have been few creative solutions for mobile devices, like PDAs or communicators, for this kind of task. One existing implementation for calendar handling is the calendar reservation and request system that was introduced in the Nokia 9000I Communicator. Most group calendars and shared calendars thus far are based on an environment of networked personal computers in fixed networks and on the idea of one common calendar database in a server somewhere in the system.

The obvious benefit of a single “team calendar” is the upward scalability. It is easy to add users to a single group calendar and the users do not need to be connected in order to provide a view to others of their personal calendar data. However, a single group calendar is not the optimal way to handle small groupings, like 2-3 persons. Also the mobility of traditional group calendar systems is poor. For both small groupings and larger upwardly scalable groups, a more flexible system of scheduling is needed to supplement or supplant the usual technique of simply selecting a motionless block of time for a reservation.

### DISCLOSURE OF THE INVENTION

The present invention helps a user to manage his time better and more flexibly. The idea of the invention is that a calendar application reserves time dynamically in the user's calendar for the user's own purposes, such as for working, exercising, or eating. Others are not allowed to book too many meetings for that week, day, or lunchtime. The user can set the limits as to which portion of his time can be allowed for reservations or meetings. If the daily or weekly or lunchtime limit is exceeded, then the application/system responds to inquiries by indicating that the user is busy at that time, which is similar to the type of indication that is already provided when a user's time is reserved. This may be called “dynamic reservation,” since it does not reserve any particular time slot from the calendar, and instead just takes care that the calendar does not become too full.

The limit can be given as an amount of time in a percentage format or as an absolute amount. For example, the user can reserve a continuous 25% of his midday from 11:00 to 1:00, or equivalently the user can reserve a continuous half hour during that midday interval.

The user can also set either one or several limits. For example, the user can require that during one working day no more than 75% is allowed to be reserved, or the user can require that no more than 30 hours be reserved for meetings during one week, or the user can put both of those two requirements into operation.

Whenever two or more users have any kind of data connection between terminals, it is possible with second-generation technology to: combine two or more calendar databases into one combined calendar database; show the superimposed calendars in all connected devices; and edit any of the individual user's calendars so that all terminals can obtain a revised superimposed display. It is easy to share and compare calendars with anyone that has the same technology platform, anywhere and anytime. There is no need for larger technology arrangements, for example the internet, to enable calendar sharing - - - all sharing is based on the wireless telephone connection between participants. However, even an internet-based system is greatly enhanced by the present invention. Only the most disciplined and regimented user will insist on always having personal time that is scheduled the exact same way every day or every week, and yet that is what users are now forced to do when they must use fixed blocks of reserved time.

The method and system of the present invention are adapted to reserve a user's personal time in an electronic schedule of the user. This they do by recording an amount of the user's personal time, and storing at least one respective interval of time during which that amount of personal time is reserved. Each amount of the personal time is less than the respective interval of time.

Moreover, the present method and system encompass receiving an electronic inquiry about the user's availability for a booking, and then determining or indicating whether the amount of personal time can fit within the respective interval in order to accommodate the booking without any scheduling conflict. A computer readable medium is also provided for implementing this invention, and a device for reserving the user's personal time is included as well.

The device comprises a personal time recorder for recording an amount of the personal time signaled by the user, and an interval storage unit for storing a respective interval of time signaled by the user, during which the amount of personal time is reserved. The device also comprises a user calendar database for integrating data from the personal time recorder and the interval storage unit into the electronic schedule.

### BRIEF DESCRIPTION OF THE DRAWINGS

FIG. 1 is a flow chart for an best embodiment of the present invention.

FIG. 2 illustrates the device of the present invention according to a best embodiment thereof.

FIG. 3 shows a system according to the present invention.

FIG. 4 illustrates a calendar of a user having dynamic reservations.

FIG. 5 illustrates a calendar of another operator without any dynamic reservations.

### BEST MODE FOR CARRYING OUT THE INVENTION

It will be useful to explain how the invention is used, by way of several examples. Then the actual operation of a best mode embodiment of the invention will be described.

Consider Jerome, who has configured his calendar so that during a working day (9:00-17:00) there must be at least two hours free. There is already a meeting booked for afternoon (12:00-17:00). Matt tries to arrange a meeting, and notices that Jerome is available from 9:00 to 12:00. Matt books a meeting from 9:00 to 10:00 and Jerome accepts it. Later, Anne wants Jerome's opinion on her new hairdo, and tries to book a meeting. Because Jerome has only two remaining hours free in his calendar, and since two hours was the minimum amount of personal free time set by him, the calendar system indicates to Anne that there is no free time in Jerome's calendar in that day.

Now consider Rocky, who has configured his lunchtime to be from 11:00 to 13:00, and it takes him one hour to eat. Rocky needs to visit a court-martial in the morning, and so has a reservation in his calendar from 8:00 to 12:00. Captain Baranov gets an idea to ask Rocky for a visit, and the Captain browses his calendar to find a suitable time. Rocky's calendar indicates that he is busy from 8:00 to 13:00. So, Captain Baranov books a meeting from 13:00 to 15:00.

A user sets an allowed utilization rate for his calendar per day or per week or per any other user-definable period. The user may also set limits for certain user-definable special times like lunchtime. These limits can be either allowed percentages of the whole time, or required free time within the whole time stated in hours and/or minutes. A particularly simple technique is to use percentages if the time need not be continuous, but to use absolute time (i.e. hours and minutes) if the time must be continuous. The user's reservation of personal time might look like this:

| Type and Amount | |
|---|---|
| of Personal Time | Respective Interval of Time |
| lunch - 30 minutes | 11 AM to 1 PM every day |
| dentist appointment - 2 hours | Jan. 6, 2004 from 9 AM to 11 AM |
| work undisturbed - 25% | 8 AM to 5 PM weekdays |
| swim - 2 hours | Weekend |
| jog - 90 minutes | 8 AM to 5 PM Monday and Tuesday |
| jog - 90 minutes | 8 AM to 5 PM Thursday and Friday |

In this table, all the reservations are dynamic, except for the dental appointment. The user-definable interval can be set freely, for example lunch being equal to a cafeteria's open hours. These settings can be part of the calendar settings in a shared calendar, or in a calendar that is synchronized with the shared calendar.

When somebody is checking a user's availability by consulting a shared calendar, the calendar system replies based on a combination of actual static events in the user's calendar plus the dynamic reservations set by the user. Or, these dynamic reservations can be implemented to appear as normal calendar items in a shared calendar, and thus the intelligence of this invention does not necessarily need to be implemented in a shared calendar system (e.g. Microsoft Outlook), even though it is implemented in another calendar (e.g. a calendar running in a mobile terminal) which is merely synchronized with the shared calendar.

Just as it is useful to sometimes reserve time in one's own schedule by specifying an amount of time along with a larger interval, so too it is useful to make bookings for non-personal time this same way. For example, when setting up a meeting, the meeting would initially appear in several attendees' schedules as an amount of time within a larger meeting interval. This meeting interval would shrink as each of the attendees makes other appointments unrelated to the meeting; at some point, one the attendees of the scheduled meeting will set a definite time for the meeting, assuming the meeting interval has not yet shrunk down to the amount of time allotted for the meeting.

When a person reserves time in his own schedule, either dynamically or in the rigid manner of the prior art, it will often be useful to specify the type of personal time that is being reserved. For example, if the time is jogging time, then the user might be more than happy for other people to go jogging with the user.

With the present dynamic invention, reservation possibilities are very flexible. The user does not need to rigidly reserve any specific time during the day in his calendar, which makes it much easier to find simultaneous free time for several participants. When a reservation for working or for reading emails or for other activities is dynamic, then it is sufficient that some time during the day or week will be set aside for the required activities.

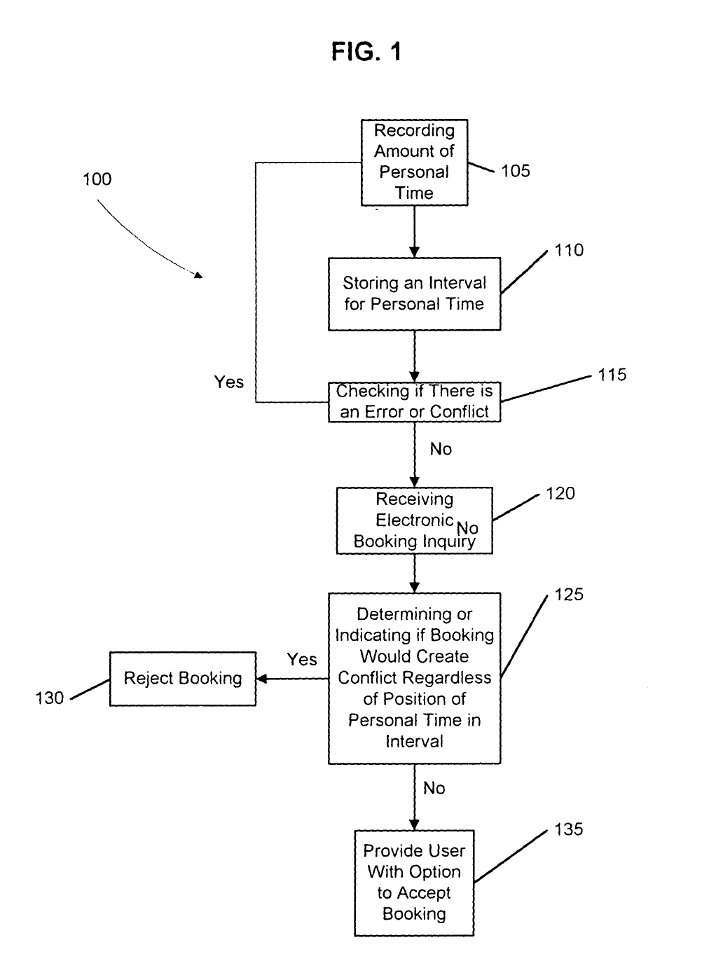

Referring now to FIG. 1, the present method 100 can be more fully understood. The purpose here is to reserve a user's personal time in an electronic schedule of the user. The first step is recording 105 at least one amount of the personal time, for example the 30-minute lunch listed in the table above. Then at least one respective interval of time is stored 110, for example 11 AM to 1 PM in the lunch example, and the at least one amount of the personal time is reserved during that interval. The personal time is less than the respective interval of time, so that the former can fit into the latter.

FIG. 1 also shows a step of checking 115 if there is an error or conflict, and such an error might be that the interval of time is less than the amount of personal time. Or, the error might be that the interval of time and the amount of personal time will inevitable conflict with reservations already made in the user's calendar. If there is an error, then the method must begin again. Assuming no error, the reservation is made, and then, in this example, an electronic booking inquiry is received 120. In other words, someone else is checking the user's availability for a booking. It is then determined or indicated 125 whether or not the booking would create a conflict regardless of the position of the personal time within the interval; if so, then the booking is rejected 130, but if not then the user is provided 135 with an option to accept the booking.

Other scenarios are possible, such as automatically making the booking, instead of asking the user. The user may have granted some people this privilege, and the privilege may be a type of privilege that can be waived at the discretion of the holder of the privilege.

Various intermediate steps can be included between those of FIG. 1. The system may ask the user whether the user accepts the booking request even if the booking causes a scheduling conflict with a static or dynamic prior reservation of the user; this gives the ultimate decision to the user, who may wish to cancel the prior reservation to make room for the new one. Also, a user availability message can be sent in response to the electronic inquiry, in order to let an inquiring operator know that the user is available and ask that operator if he or she would like to go ahead and request the booking.

The electronic inquiry itself can indicate, instead of a normal booking, a dynamic booking. That would include an amount of booking time, and a booking interval that is greater than or equal to the booking time. Both would be booked. This is the type of situation where perhaps the inquiring operator is very flexible about when she can be available for a meeting or other event, and would like to make a booking that will remain very flexible so that later more people might be able to join the event than otherwise would have been possible. As additional people agree to the booking, the additional reservations effectively cause a contraction of the booking interval. In other words, each additional participant in the booking may have additional requirements about when it will occur. This method, of course, may be implemented by appropriate software, i.e. on a computer-readable medium or media for use in a terminal, the medium or media being encoded with at least part of a data structure for performing the method.

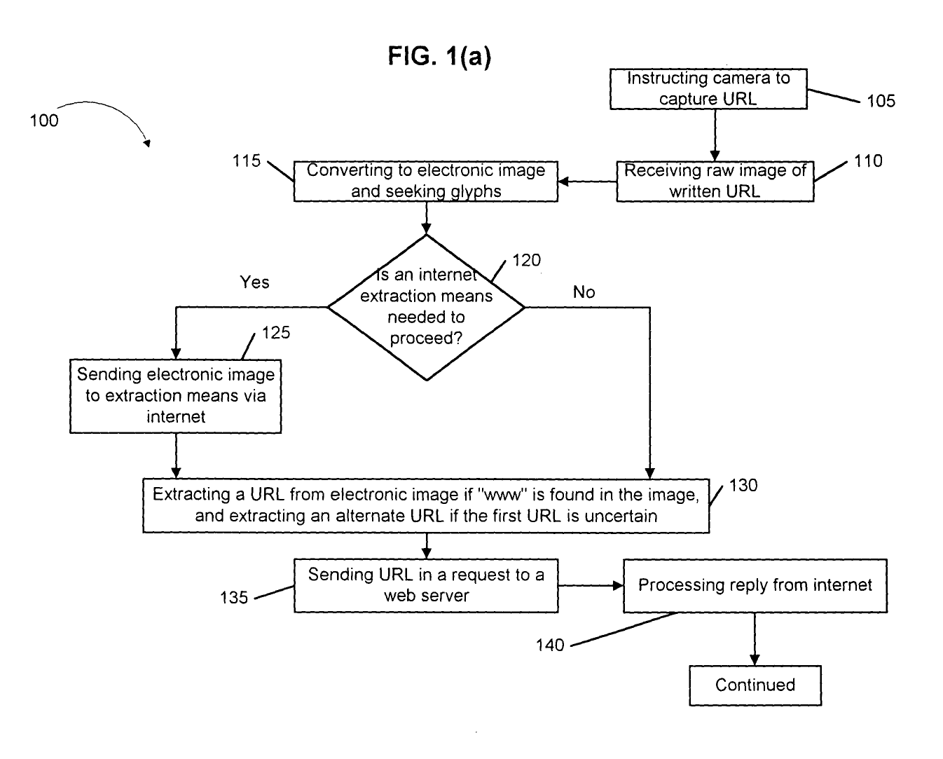

Turning now to FIG. 2, a device is shown which is also referred to as a user scheduling device. This device 200 is for reserving a user's personal time in an electronic schedule of the user. The device includes a personal time recorder 205, responsive to a personal time signal 210 from the user, for recording at least one amount of the personal time. The device also includes an interval storage unit 215, responsive to an interval signal 220 from the user, for storing at least one respective interval of time during which the at least one amount of personal time is reserved. The device 200 further includes a user calendar database 225, for integrating data from the personal time recorder 205 and the interval storage unit 215 into the electronic schedule.

Also shown in FIG. 2 is an error check unit 230 for notifying the user via signal 235 if the amount of the personal time is more than the respective interval, or if the personal time and the respective interval cause any conflict with scheduling information already integrated into the user calendar database 225. This device 200 can be a mobile or a fixed terminal that interacts directly with the user, or it can be a device or server that is in communication with a user terminal.

The device 200 further includes an inquiry processing unit 240, which is responsive to an inquiry signal 245. This inquiry processing unit 240 is for accessing the user calendar database 225 in order for the device 200 to provide an availability indicator signal 250 indicative of whether the at least one amount of personal time can fit within the at least one respective interval so as to accommodate a booking without any scheduling conflict. The recipient of the availability indicator signal may then go ahead and actually request the booking, via the reservation request signal 255. The user would then receive a user option signal 260 giving the user the option to make the booking in the user's schedule (“schedule” is here synonymous with “calendar”). Then, the user may agree to the booking, by sending the booking signal 265.

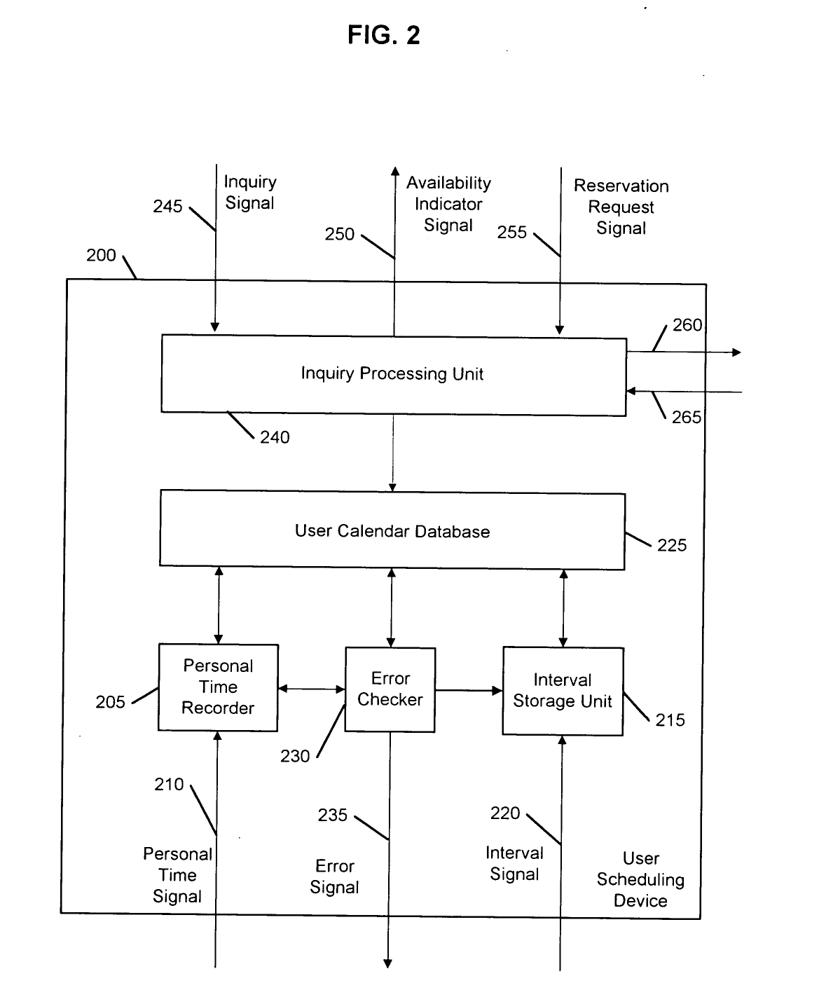

FIG. 3 depicts a 300 according to the present invention. This system is for reserving a user's personal time in an electronic schedule of the user. The system includes a user terminal 310, responsive to user input, for providing a personal time and interval signal 315 indicative of at least one amount of personal time and a respective interval of time during which the at least one amount of personal time is reserved. The system also includes a user scheduling device 320, responsive to the personal time and interval signal 315, for providing a booking availability signal 325 indicative of whether the personal time can be situated within the interval so that a booking fits into the electronic schedule. Additionally, the system 300 includes an inquiring terminal 330, responsive to the availability signal 325, for indicating to an operator of the inquiring terminal whether the amount of personal time can be situated within the interval so that a booking fits into the electronic schedule.

It is to be noted that the user scheduling device 300 may also perform at least some scheduling for the operator of the inquiring terminal. The user scheduling device may produces a superposition of calendars corresponding to the user of the user terminal and the operator of the inquiring terminal, or can maintain a joint calendar.

It is also to be observed that the user terminal 310 may have the same capabilities as the inquiring terminal 330, in which case they would be capable of switching roles. Also, it is to be noted that the system 300 is only one possible embodiment, and others are within the scope of the invention, such as an embodiment wherein the user scheduling device 320 is part of the user terminal 310.

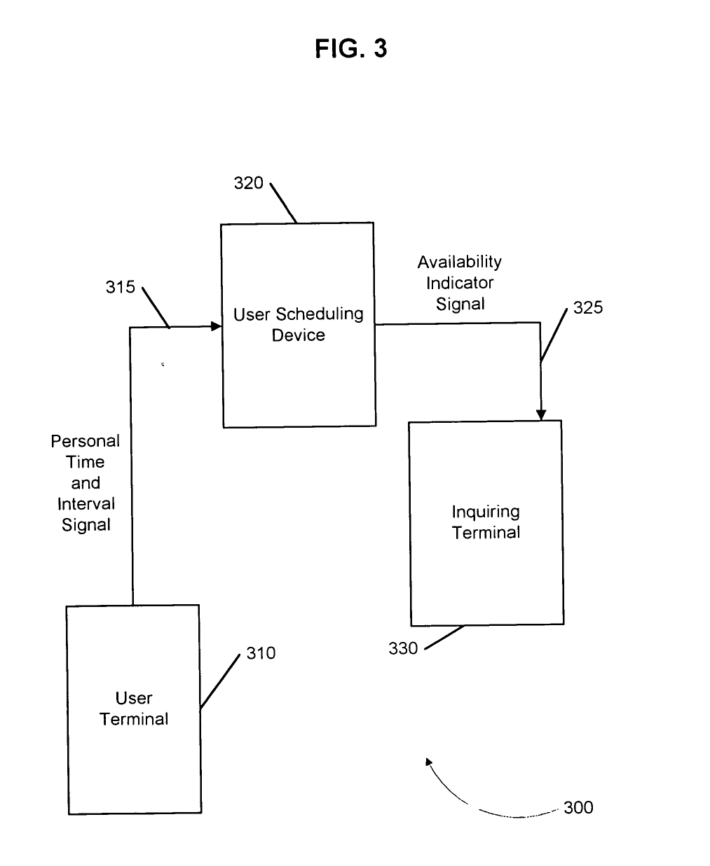

Turning now to FIG. 4, this provides an example of a daily schedule of a user having dynamic reservations. For purposes of this example, the capitalization of the items in FIG. 4 is critical. The entry on Monday for a “jog” means that two hours are allotted to the jog, and those two hours can occur any time between 13:00 and 16:00 (i.e. between 1 PM and 4 PM). The meeting on Tuesday is rigidly reserved for the entire two hours from 9:00 to 11:00. On Wednesday, one hour for lunch is alotted, and it can be anytime between 11:00 and 14:00. On Thursday, time for a two-hour seminar is rigidly reserved. On Saturday, two hours are allotted for a swim, anytime between 10:00 and 14:00. This technique for making dynamic reservations is only an example, and in fact other techniques may well be necessary for different types of dynamic reservations, such as a reservation of 25% of the week for undisturbed work.

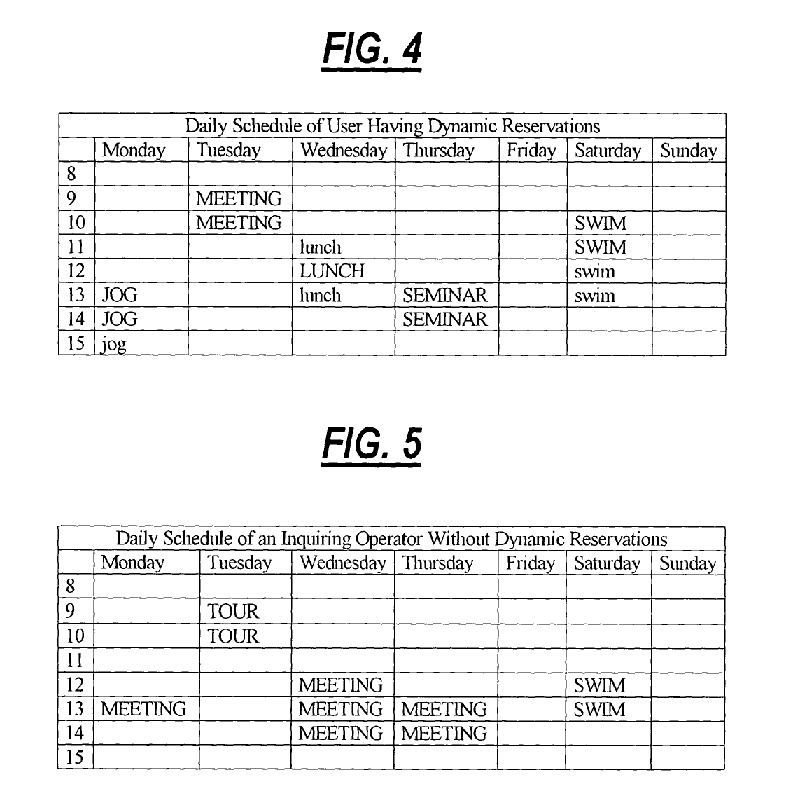

In contrast to FIG. 4, FIG. 5 simply shows ordinary, rigid reservations of an inquiring operator. Of course, by an “operator” is meant a user of a terminal, and the word “operator” is simply used to help distinguish from the other user. The inquiring operator can obtain the information he or she needs by examining the calendars of FIG. 4 and FIG. 5 separately, or the two calendars can be superimposed. In any event, the inquiring operator will see that the user can accommodate his jogging schedule on Monday to attend the meeting from 13:00 to 14:00. The inquiring operator will also see that the user is completely unavailable for the tour on Tuesday, but that the user can accommodate his lunch schedule to attend the three-hour meeting on Wednesday. The user is attending a seminar on Thursday that would prevent him from attending the meeting that is on the inquiring operator's schedule. As far as Saturday is concerned, the user is available to have some overlapping swim-time with the inquiring operator.

It should be recognized that each signal described in this disclosure is defined broadly as a cause and effect relationship. The signal may be direct or indirect, may comprise any number of intermediate steps, and may be integrated together with other signals, as will be understood by those skilled in the art. Likewise, the various structural elements described herein will be understood by skilled artisans to represent conceptual entities that can be implemented by a variety of software and hardware, and in numerous configurations.

Although this invention has been shown and described with respect to a best mode thereof, it should be understood by those skilled in the art that the foregoing and various other changes, omissions and additions in the form and detail thereof may be made therein without departing from the spirit of the invention and the scope of the claims.

1. A method to reserve a user's personal time in an electronic schedule of the user, comprising the steps of:
recording at least one amount of the personal time; and
storing at least one respective interval of time during which the at least one amount of the personal time is reserved,
wherein each of the at least one amount of the personal time is less than the respective interval of time.

2. The method of claim 1, further comprising the steps of:
receiving an electronic inquiry about the user's availability for a booking;
determining or indicating whether the at least one amount of personal time can fit within the at least one respective interval in order to accommodate the booking without causing a scheduling conflict.

3. The method of claim 2, further comprising the step of providing the user with an option whether or not to accept the booking, in case of a positive determination or indication that the personal time can fit.

4. The method of claim 2, further comprising the step of automatically making the booking, in case of a positive determination or indication that the personal time can fit.

5. The method of claim 2, further comprising the step of sending a user availability message in response to the electronic inquiry, in case of a positive determination or indication that the personal time can fit.

6. The method of claim 2, further comprising the step providing the user with a conflict notification and an option whether or not to accept the booking, in case of a negative determination or indication that the personal time cannot fit.

7. The method of claim 1, wherein the at least one respective interval of time represents the user's midday, workday, work week, or any user definable period.

8. The method of claim 1, wherein the at least one amount of the personal time is given as a percentage of the respective interval of time.

9. The method of claim 1, wherein the at least one amount of the personal time is given as a particular continuous or non-continuous duration.

10. The method of claim 1, further comprising the step of reserving at least one fixed block of the personal time.

11. The method of claim 2, further comprising the steps of comparing a booking type to a type of the personal time, and if consistent then the scheduling conflict will not occur.

12. The method of claim 2, wherein the electronic inquiry indicates at least one amount of booking time, and at least one respective booking interval that is greater than or equal to the booking time.

13. The method of claim 5, wherein the user availability message includes a question as to whether the availability should be confirmed by consulting the user.

14. The method of claim 12, wherein there is a positive determination or indication that the personal time can fit, and the booking is made by booking both the booking time as well as the respective booking interval which is greater than the booking time.

15. The method of claim 14, wherein a further reservation effectively causes a contraction of the booking interval.

16. The method of claim 1, further comprising the step of displaying the amount of the personal time and the respective interval of time on a shared or individual calendar.

17. A computer-readable medium or media for use in a terminal, the medium or media being encoded with at least part of a data structure for performing the method of claim 1.

18. A device for reserving a user's personal time in an electronic schedule of the user, comprising:
a personal time recorder, responsive to a personal time signal from the user, for recording at least one amount of the personal time;
an interval storage unit, responsive to an interval signal from the user, for storing at least one respective interval of time during which the at least one amount of personal time is reserved; and
a user calendar database, for integrating data from the personal time recorder and the interval storage unit into the electronic schedule.

19. The device of claim 18, further comprising an error check unit for notifying the user if the amount of the personal time is more than the respective interval, or if the personal time and the respective interval cause any conflict with scheduling information already integrated into the user calendar database.

20. The device of claim 18, wherein the device is a mobile or fixed terminal that interacts directly with the user.

21. The device of claim 18, wherein the device is a server located remotely from a user terminal.

22. The device of claim 18, further comprising an inquiry processing unit, responsive to an inquiry signal, for accessing the user calendar database in order for the device to provide an availability indicator signal indicative of whether the at least one amount of personal time can fit within the at least one respective interval so as to accommodate a booking without any scheduling conflict.

23. A system for reserving a user's personal time in an electronic schedule of the user, comprising:
a user terminal, responsive to user input, for providing a personal time and interval signal indicative of at least one amount of personal time and a respective interval of time during which the at least one amount of personal time is reserved;
a user scheduling device, responsive to the personal time and interval signal, for providing a booking availability signal indicative of whether the at least one amount of personal time can be situated so that a booking fits into the electronic schedule; and
an inquiring terminal, responsive to the booking availability signal, for indicating to an operator of the inquiring terminal whether the at least one amount of personal time can be situated within the interval so that a booking fits into the electronic schedule.

24. The system of claim 23, wherein the user scheduling device also is for performing at least some scheduling for the operator of the inquiring terminal.

25. The system of claim 24, wherein the user scheduling device produces a superposition of calendars corresponding to the user of the user terminal and the operator of the inquiring terminal.

26. The system of claim 23, wherein the user scheduling device is located in or with the user terminal.
